(19) United States
(12) Patent Application Publication
(10) Pub. No.: US 2008/0182662 A1
(43) Pub. Date: Jul. 31, 2008

(54) SIMULTANEOUS MULTIPLAYER GAMING MACHINE AND METHOD OF CONTROLLING THE SAME

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/014,904

(22) Filed: Jan. 16, 2008

(30) Foreign Application Priority Data
Jan. 23, 2007 (JP) JP2007-013130

(51) Int. Cl. A63F 13/00

(52) U.S. Cl. 463/31; 463/20

(57) ABSTRACT

A gaming machine is configured of: stations each for individually carrying out a slot game; a display visible to players each playing the game in one of the stations; and a control device configured to control progress of game situation in the entire system, and the like. The gaming machine causes each of the stations to rearrange multiple symbols having attributes different from each other, and to provide an award on the basis of whether or not any one of predetermined combinations is formed as an outcome of the rearrangement. Subsequently, the gaming machine carries out a secondary game on the display, and provides an award according to a relationship between an outcome of the slot game and an outcome of the secondary game.

### CROSS REFERENCE TO RELATED APPLICATION

This application is based upon and claims the benefit of priority from Japanese Patent Application No. 2007-13130 filed on Jan. 23, 2007, the entire contents of which are incorporated herein by reference.

### BACKGROUND OF THE INVENTION

1. Field of the Invention

The present invention relates to a multiplayer gaming machine including gaming devices through which multiple player participate in a game by using gaming media such as coins and bills, and to a method of controlling the gaming machine.

2. Description of the Related Art

Generally, a so-called stand-alone gaming machine is known as a conventional gaming machine as described in US Patent No. 6981635. Generally, conventional types of slot machines are what are called stand-alone gaming machines such as a gaming device disclosed in U.S. Pat. No. 6,981,635. Further, U.S. Pat. No. 7,040,984 discloses a gaming device which includes multiple slot machines linked together through a central control device, and which varies the amounts of awards provided to the respective slot machines according to their rankings in a game played through the multiple slot machines thus linked.

Meanwhile, card games using playing cards, roulette games and the like enable multiple players to participate in, and to simultaneously play a game, unlike slot machine games each causing a player (a person) to play a game against the gaming machine. Those games allowing multiple players to play together are termed as mass games.

The slot machines shown in U.S. Pat. No. 7,040,984 do not share the contents of a game, although the slot machines are linked together through the central control device. That is because an actual game is played in each of the slot machines in a stand-alone mode, independently of the rest of the slot machines.

### SUMMARY OF THE INVENTION

An object of the present invention is to provide a simultaneous multiplayer gaming machine having new entertainment features by adding excellent entertainment features of a conventional and stand-alone gaming device to a simultaneous multiplayer game, and to provide a method of controlling a game played in the simultaneous multiplayer gaming machine.

A first aspect of the present invention provides a gaming machine comprising: a plurality of gaming devices each for carrying out a game in which a plurality of symbols having attributes different from each other are changed and subsequently stopped; a shared gaming device for carrying out a shared game shared by the gaming devices; and a display adapted to display the shared game, the display being visible to players each playing the game in one of the gaming devices. Each of the gaming devices is operable to: (a) change the plurality of symbols and subsequently stop them; and (b) provide an award on the basis of a relationship between a combination of the symbols formed when the symbols are stopped and an outcome of the shared game.

In the foregoing configuration, each of the multiple gaming devices carries out a game in which multiple symbols having attributes different from each other are changed and subsequently stopped, the shared gaming device carries out a shared game shared by the gaming devices, and the display displays how the shared game is going on. Each of the gaming devices provides an award according to the relationship between the outcome of the shared game and the combination of the symbols formed when the symbols are stopped after being changed.

Accordingly, by enabling each of the gaming devices to provide the award according to the relationship between the outcome of the shared game and the combination of the symbols formed when the symbols are stopped after being changed, excellent entertainment features of the gaming device of the stand-alone type can be applied to the simultaneous multiplayer game. In addition, this makes it possible to provide a simultaneous multiplayer gaming machine having new entertainment features.

A second aspect of the present invention provides a gaming machine comprising: a plurality of gaming devices each for carrying out a game in which a plurality of symbols having attributes different from each other are changed and subsequently stopped; a shared gaming device for carrying out a shared game in which predetermined symbols are sampled from a plurality of symbols including the symbols used in each of the gaming devices; and a display adapted to display a content of the shared game, the display being visible to players each playing the game in one of the gaming devices. Each of the gaming devices is operable to: (a) change the plurality of symbols and subsequently stop them; and (b) provide an award according to a relationship between a combination of the symbols formed when the symbols are stopped and the predetermined symbols sampled in the shared game.

In the foregoing configuration, each of the gaming devices carries out a game in which multiple symbols are changed and subsequently stopped, the shared gaming device carries out a shared game in which the predetermined symbols are sampled from the multiple symbols including the symbols used in each of the gaming devices, and the display displays how the shared game is going on. Each of the gaming devices provide an award according to the relationship between the outcome of the shared game and the combination of the symbols formed when the symbols are stopped after being changed.

Accordingly, by enabling each of the gaming devices to provide the award according to the relationship between the outcome of the shared game and the combination of the symbols formed when the symbols are stopped after being changed, excellent entertainment features of the gaming device of the stand-alone type can be applied to the simultaneous multiplayer game. In addition, this makes it possible to provide a simultaneous multiplayer gaming machine having new entertainment features.

A third aspect of the present invention provides a gaming machine comprising: a plurality of primary gaming devices each for carrying out a primary game in which a plurality of symbols having attributes different from each other are changed and subsequently stopped; a secondary gaming device for carrying out a secondary game in which predetermined symbols are sampled from a plurality of symbols including the symbols used in the primary game in each of the primary gaming devices; and a display adapted to display a content of the secondary game, the display being visible to players each playing the primary game in one of the primary gaming devices. Each of the primary gaming devices is operable to: (a) change the plurality of symbols and subsequently stop them as the primary game; and (b) provide an award according to a relationship between a combination of the symbols formed when the symbols are stopped in the primary game and the predetermined symbols sampled in the secondary game. The secondary gaming device is operable to (c) execute a control such that the secondary game can be started at a timing when the primary game is completed in each of the primary gaming devices, and that the symbols sampled in the secondary game can be supplied to the primary game.

In the foregoing configuration, each of the primary gaming devices carries out the primary game in which the multiple symbols are changed and subsequently stopped, the secondary gaming device carries out the secondary game in which the predetermined symbols are sampled from the multiple symbols including the symbols used in the primary game, and the display displays how the secondary game is going on. Once each of the primary gaming devices carries out the primary game in which the multiple symbols are changed and subsequently stopped, the secondary gaming device starts the secondary game at the timing when the primary game is completed in each of the primary gaming devices. Thereafter, each of the primary gaming devices provides an award according to a relationship between the predetermined symbols sampled in the secondary game and the combination of the symbols formed when the symbols are stopped in the primary game.

Accordingly, by enabling each of the primary gaming devices to provide the award according to the relationship between the predetermined symbols sampled in the secondary game and the combination of the symbols formed when the symbols are stopped after being changed in the primary game, excellent entertainment features of the gaming device of the stand-alone type can be applied to the simultaneous multiplayer game. In addition, this makes it possible to provide a simultaneous multiplayer gaming machine having new entertainment features.

A fourth aspect of the present invention provides a method of controlling a gaming machine including a shared gaming device and a plurality of gaming devices, comprising: causing each of the plurality of gaming devices to change and subsequently stop a plurality of symbols having attributes different from each other; causing a shared gaming device to sample predetermined symbols from a plurality of symbols including the symbols used in each of the gaming devices as a shared game displayed on a display; and providing an award according to a relationship between a combination of the plurality of symbols which are changed and subsequently stopped in each of the gaming devices and an outcome of the shared game.

In the foregoing configuration, each of the multiple gaming devices carries out the game in which multiple symbols having attributes different from each other are changed and subsequently stopped, the shared gaming device carries out the shared game shared by the gaming devices, and the display displays the shared game. An award is provided according to the relationship between the outcome of the shared game and the combination of the multiple symbols formed when the symbols are stopped after being stopped.

Accordingly, by enabling each of the gaming devices to provide the award according to the relationship between the outcome of the shared game and the combination of the symbols formed when the symbols are stopped after being changed, excellent entertainment features of the gaming device of the stand-alone type can be applied to the simultaneous multiplayer game.

The gaming machine and the method of controlling a game played in the gaming machine according to the present invention are capable of adding excellent entertainment features of a conventional and stand-alone gaming device to a simultaneous multiplayer game, and thereby providing new entertainment features to the simultaneous multiplayer game.

### BRIEF DESCRIPTION OF THE DRAWINGS

FIG. 1 is a diagram illustrating an example of a game screen and an effect image displayed in a display for the purpose of explaining characteristics of a game machine according to an embodiment of the present invention.

FIG. 2 is a schematic diagram illustrating an outline of the game machine according to the embodiment of the present invention.

FIG. 3 is a perspective view illustrating an appearance of the game machine according to the embodiment of the present invention.

FIG. 4 is a block diagram illustrating the game machine according to the embodiment of the present invention.

FIG. 5 is an explanatory diagram illustrating memory areas in a RAM in a control device in the game machine according to the embodiment of the present invention.

FIG. 6 is a block diagram illustrating a station in the game machine according to the embodiment of the present invention.

FIG. 7 is an explanatory diagram illustrating an example of symbols used in a slot game according to the embodiment of the present invention.

FIG. 8 is an explanatory diagram illustrating an example of symbols used in a secondary game according to the embodiment of the present invention.

FIG. 9 is an explanatory diagram showing an example of the payout table for combinations of symbols used in a slot game according to the embodiment of the present invention.

FIG. 10 is an explanatory diagram showing an example of a payout table for scatter symbols used in a slot game according to the embodiment of the present invention.

FIG. 11 is an explanatory diagram showing an example of a random number table for a primary game according to the embodiment of the present invention.

FIG. 12 is an explanatory diagram showing an example of a payout table determined on the basis of an outcome of a secondary game according to the embodiment of the present invention.

FIG. 13A is a flowchart illustrating the primary and second game processes respectively performed in a station and a control device, which constitute the gaming machine according to the embodiment of the present invention.

FIG. 13B is a flowchart illustrating the primary and second game processes respectively performed in a station and a control device, which constitute the gaming machine according to the embodiment of the present invention.

FIG. 14 is an explanatory diagram illustrating an example of a game screen which is displayed on the display device in the station in the course of continued progress of the slot game carried out on the basis of the process shown in FIGS. 13A and 13B.

FIG. 15 is another explanatory diagram illustrating an example of a game screen which is displayed on the display device in the station in the course of continued progress of the slot game carried out on the basis of the process shown in FIGS. 13A and 13B.

FIG. 16 is another explanatory diagram illustrating an example of a game screen which is displayed on the display device in the station in the course of continued progress of the slot game carried out on the basis of the process shown in FIGS. 13A and 13B.

### DETAILED DESCRIPTION OF THE EMBODIMENT

According to an embodiment of the present invention, a gaming machine 1 is configured chiefly of stations 4, a display 20, and a control device (shared gaming device) 13. The stations 4 are gaming devices in each of which a game of rearranging symbols is carried out. The display 20 is visible to players playing their games in their respective gaming devices. The control device 13 is configured to control progress of game situation in the entire system, and the like. The gaming machine 1 is a game system enabling the games in each of which the symbols are changed to be rearranged. In the present embodiment, a game is carried out in which a payout (an award) is provided on the basis of a combination of symbols rearranged in 5 columns ×3 rows, a total of 15 symbol displaying sub-regions (62aX to 62eZ) displayed on each of display devices 8 in the station 4. The symbols include a “HORSE” symbol, a “SPADE” symbol, a “HEART” symbol, a “DIAMOND” symbol and a “CLUB” symbol. In the present embodiment, the 15 symbol displaying sub-regions 62aX to 62eZ are organized into the 5 columns each consisting of three sub-regions X to Z. The symbols in the columns are scrolled vertically so that each of the columns can look like a reel and thereafter stopped. An operation of scrolling and stopping the symbols will be hereinafter referred to as a “rearrangement”, and is performed in each of the stations 4. A game in which the symbols are rearranged is termed as a primary game.

An aspect of the gaming machine 1 shown as the embodiment of the present invention includes: carrying out a shared game shared by all the players (all the participating stations 4) on the display 20 after the players play their primary games in their stations 4 so that the symbols are rearranged in each of the stations 4; and determining, for example, whether or not to provide a payout (an award), or what amount of payout (what kind of award) to provide are determined on the basis of a relationship between an outcome of the primary game determined in the corresponding one of the stations 4 and an outcome of a game played as a shared game (hereinafter referred to as a “secondary game”).

Specifically, unlike a conventional slot game carried out in a stand-alone manner, a game according to the present embodiment is carried out as follows. Firstly, a symbol combination is determined as an outcome of the rearrangement in a slot game in the stand-alone manner. Subsequently, a shared game providing symbols is carried out on the display 20 as a shared game shared by the stations connected to the game system, and one or more symbols are sampled as an outcome of the shared game. Thereafter, in each of the stations, the symbols sampled in the shared game are reflected on the outcome of the rearrangement in the slot game so that a final symbol combination can be determined. Finally, a payout (an award) is provided on the basis of the final symbol combination.

The secondary game is carried out by the control device after the outcome of the primary game is displayed in each of the stations 4. In the present embodiment, the secondary game carried out on the display 20 is a horse racing game. An image of multiple horses racing for a goal is displayed on the display 20. The horses are marked with characteristics of the symbols (one of 8 colors and one of the symbols of “SPADE”, “HEART”, “DIAMOND” and “CLUB” in the present embodiment) used for the slot game carried out in each of the stations 4.

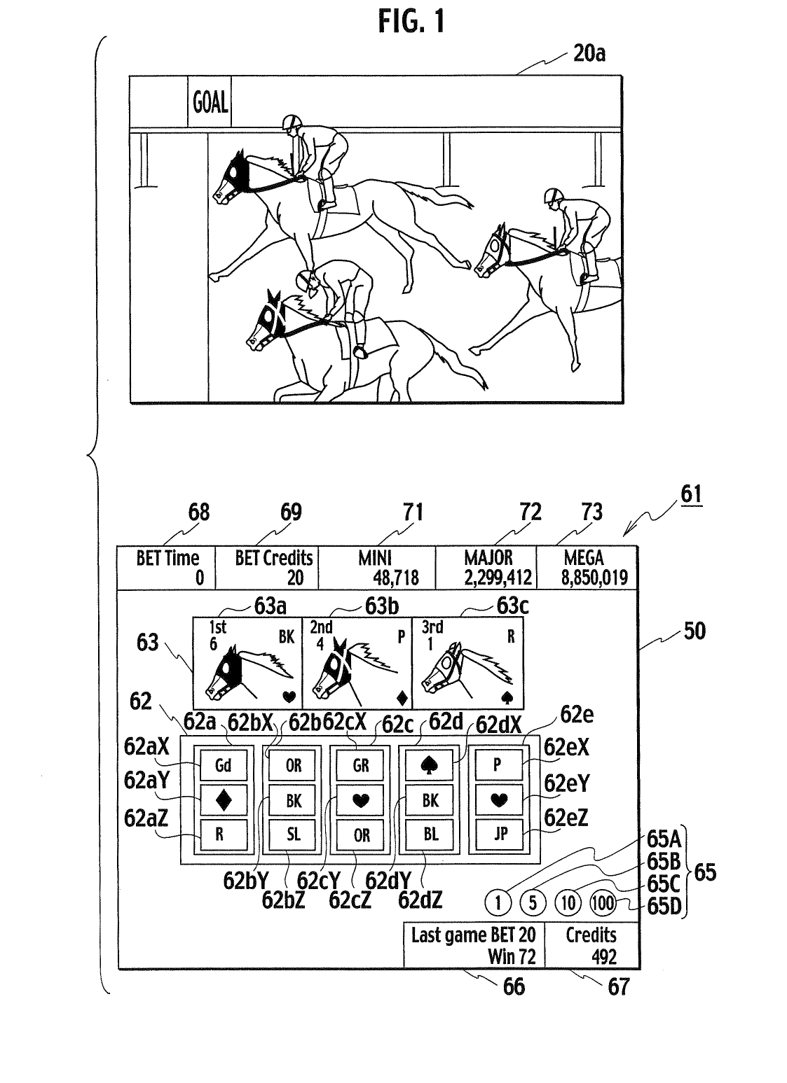

FIG. 1 shows an example of a game screen displayed to a player, which represents characteristics of the gaming machine 1 shown as the present embodiment. During a slot game carried out as a primary game, a game screen 61 is displayed on the display device 8, which will be described later, of the station 4. The player can perform an action such as starting a slot game or making a bet by use of credits on hand, by performing an operation of touching a predetermined display section of a touch panel 50 provided on the front surface of the display device 8. Once the player performs an operation for starting a slot game in accordance with a predetermined procedure, the symbols start being changed in the symbol displaying region 62.

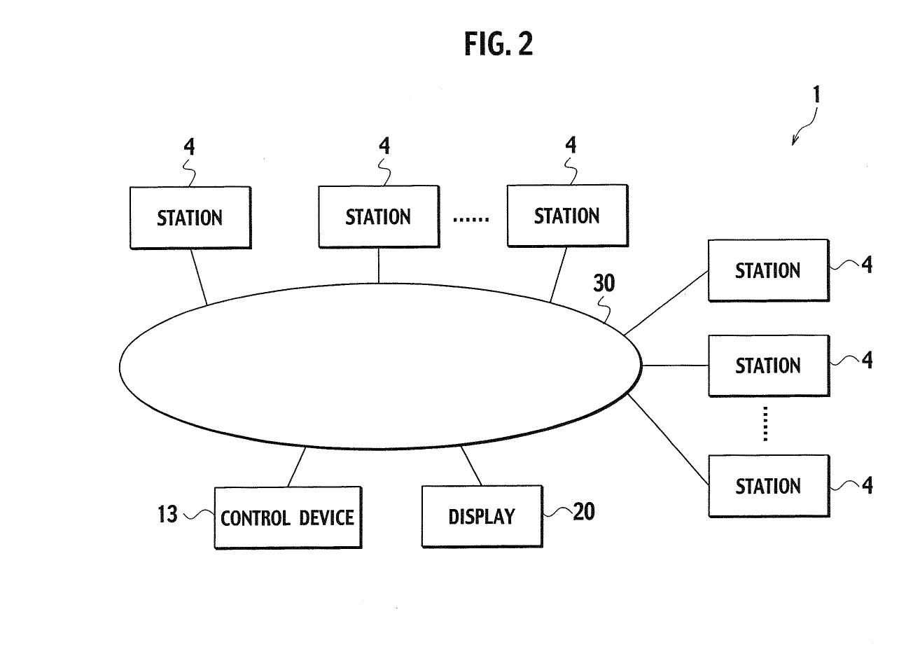

The upper half of FIG. 1 shows an example of an effect image for a secondary game displayed in a display panel 20a of the display 20. The lower half of FIG. 2 shows an example of a game screen displayed on the display device 8 in the game device termed as the station 4.

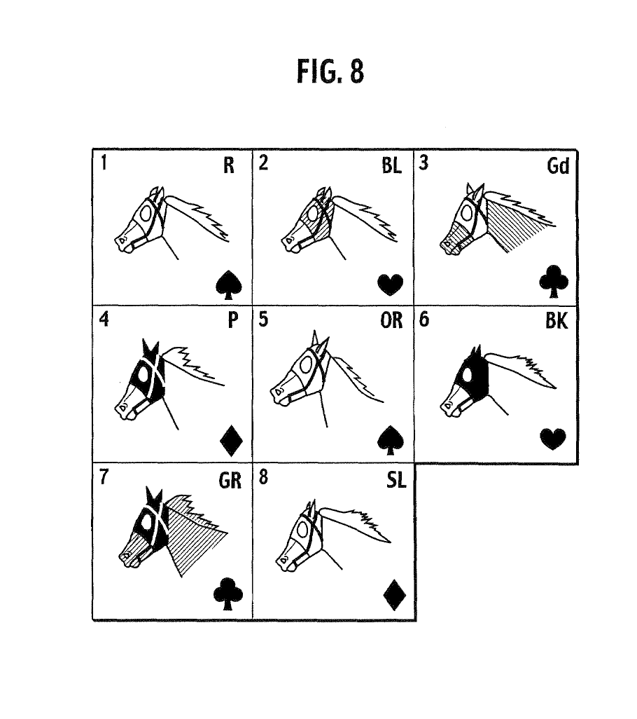

The display panel 20a in the display 20 shown in the upper half of FIG. 1 shows a scene in which a racing horse reaches the goal. FIG. 1 shows the number 6 horse, the number 4 horse and the number 1 horse reach the goal in this order out of the 8 horses (see the 8 “HORSE” symbols shown in FIG. 8), although descriptions thereof will be given later in detail. In addition, the game screen 60 shown in the lower half of FIG. 1 displays the outcome of the primary game in the symbol displaying region 62, and the race rankings of horses as the outcome of the secondary game in a secondary game outcome displaying section 63.

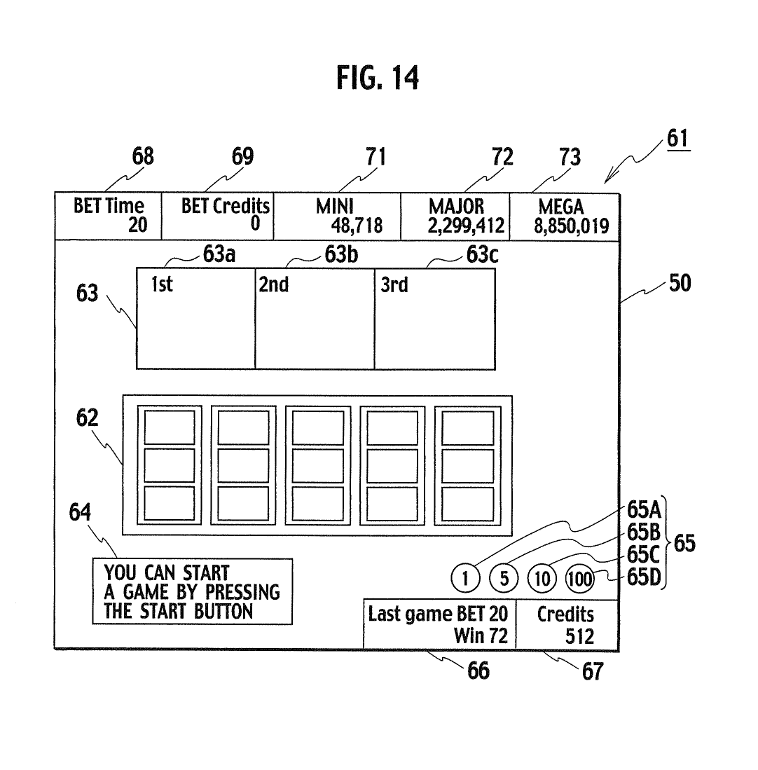

The game screen 61 includes: the symbol displaying region 62 (symbol displaying sub-regions 62aX to 62eZ) for displaying the primary game; the secondary game result displaying section 63 for displaying the placing as an outcome of the secondary game; a message displaying section 64 (see FIG. 14) for displaying a message or the like concerning the primary or secondary game; unit bet buttons 65; a payout result displaying section 66 for displaying a payout result in the previous game; and a credit amount displaying section 67 for displaying the amount of credits currently possessed by the player.

In addition, the game screen 61 includes: a bet-allowable remaining time displaying section 68 for displaying a remaining time during which the player is allowed to make a bet operation; a bet amount displaying section 69 for displaying the amount of credits bet on a slot game; a MINI displaying section 71 for displaying the amount of credits accumulated for a jackpot (hereinafter shortened to “JP” in some cases) MINI; a MAJOR displaying section 72 for displaying the amount of credits accumulated for a JP MAJOR; and a MEGA displaying section 73 for displaying the amount of credits accumulated for a JP MEGA.

An outcome of the primary game is displayed in the symbol displaying region 62. FIG. 1 shows what “HORSE” symbols are rearranged in each of the symbol displaying region 62 as an outcome of a previous primary game carried out in a station 4. In this example shown in FIG. 1, a “Gd (gold) HORSE” symbol is rearranged in a symbol displaying sub-region 62aX; a “DIAMOND” symbol, 62aY; a “R (red) HORSE” symbol, 62aZ; an “OR (orange) HORSE” symbol, 62bX; a “BK (black) HORSE” symbol, 62bY; a “SL (silver) HORSE” symbol, 62bZ; a “GR (green) HORSE” symbol, 62cX; a “HEART” symbol, 62cY; an “OR HORSE” symbol, 62cZ; a “SPADE” symbol, 62dX; a “BK HORSE” symbol, 62dY; a “BL (blue) HORSE” symbol, 62dZ; a “P (pink) HORSE” symbol, 62eX; a “HEART” symbol, 62eY; a “JP (jackpot)” symbol, 62eZ. Note that although just the characters such as “Gd” are illustrated in the symbol displaying region 62 in FIG. 1 for both simplicity and clarifying the main points of the present invention, actually, a vivid image representing a horse' s picture, a horse' s physical characteristics, and one of the 8 colors for distinguishing the racing horses is displayed in each of the symbol displaying sub-regions in which these characters are illustrated.

The secondary game outcome displaying section 63 displays the race rankings of horses on the basis of an outcome of the secondary game displayed on the display 20. For example, the first finishing “BK HORSE” symbol, the second finishing “P HORSE” symbol and the third finishing “R HORSE” symbol are displayed thereon, as shown in FIG. 1. As shown in each of the “HORSE” symbols in the secondary game is combined with one of the symbols of “SPADE”, “HEART”, “DIAMOND” and “CLUB,” and the players are allowed to know these associations before the start of each race (see FIG. 8). When the ranking is determined, information on “SPADE”, “HEART”, “DIAMOND” and “CLUB,” combined with the horse symbols as well as the placing is simultaneously displayed in the secondary game outcome displaying section 63.

On the basis of the progress of the primary or secondary game, the message display section 64 displays a related message. For example, “BET to Start a Game,” and “Horse Racing Game Starts!” are displayed thereon, although described later.

The unit BET buttons 65 are those through which the player who has determined to start to play a game inputs the amount of credits to be bet on the game. The unit BET buttons 65 are constituted of a 1-credit BET button 65A, a 5-credit BET button 65B, a 10-credit BET button 65C and a 100-credit BET button 65D. The player can bet credits in the amount which the player indicates by pressing down these four buttons.

By touching the location where the 1-credit bet button 65A is displayed, the player can bet 1 credit at a time. Each time the player touches the 1-credit bet button 65A, the amount of credits increases sequentially, “1,” “2,” “3,” . . . , and is displayed in the bet amount displaying section 69. By touching the location where the 5-credit bet button 65B is displayed, the player can bet 5 credits at a time. Each time the player touches the 5-credit bet button 65B, the amount of credits increases sequentially, “5,” “10, ” “15,” . . . . By touching the location where the 10-credit bet button 65C is displayed, the player can bet 10 credits at a time. Each time the player touches the 10-credit bet button 65C, the amount of credits increases sequentially, “10,” “20,” “30,” . . . . By touching the location where the 100-credit bet button 65D is displayed, the player can bet 100 credits at a time. Each time the player touches the 100-credit bet button 65D, the amount of credits increases sequentially, “100,” “200,” “300, ” . . . .

The payout result displaying section 66 displays the amount of credits which the player bet on the previous game, and the amount of credits paid out (the amount of the award provided) on the previous game. In this respect, an amount number obtained by subtracting the amount of credits bet on the previous game from the amount of credits paid out on the previous game means the amount of credits (awards) which the player newly earned on the previous game.

The credit amount displaying section 67 displays the amount of credits which the player currently possesses. When a bet is made, the amount of credits displayed on the credit amount displaying section 67 decreases by the amount of credits bet. For example, the amount of credits decreases by 1 for each bet of 1 credit. On the other hand, in a case where a combination entitled to a payout is formed and the payout is provided, the amount of credits increases by the amount of credits thus paid out to the player. Incidentally, when the amount of credits which the player possesses reduces to 0, the game is over.

The bet-allowable remaining time displaying section 68 displays a remaining time during which the player is allowed to make a bet. For example, the bet allowable remaining time displaying section 68 displays the number “20” when starting to accept a bet operation. The number decreases by 1 every second, and a bet operation is no longer accepted when the number reduces to “0.” Moreover, when the number reduced to “0” in every station 4, the symbols start scrolling in the symbol displaying region 62, and thereby a primary game is started.

The bet amount displaying section 69 displays the amount of credits the player specifies by touching one or more of the unit BET buttons 65. The maximum or minimum amount of credits that can be bet is determined in advance in accordance with a rule of a slot game carried out in the station 4.

The MINI displaying section 71 displays the amount of credits so far accumulated for a JP “MINI.” The MAJOR displaying section 72 displays the amount of credits so far accumulated for a JP “MAJOR.” The MEGA displaying section 73 displays the amount of credits so far accumulated for a JP “MEGA.” In the present embodiment, for example, 0.15% of the total credits bet on the slot games carried out in all the 12 stations 4 are accumulated and stored as the JP “MEGA.” 0.20% of the total credits bet on the slot games carried out in all the stations 4 are accumulated and stored as the JP “MAJOR.” 0.30% of the total credits bet on the slot games carried out in all the stations 4 are stored as the JP “MAJOR.” Accordingly, the numbers displayed respectively on the MINI displaying section 71, the MAJOR displaying section 72 and the MEGA displaying section 73 are shared by all the stations 4.

When a predetermined JP combination is formed in a slot game in any of the stations 4, out of the JPs displayed on the respective displaying sections 71 to 73, credits corresponding to a JP determined to be paid are paid out to the player. After this credit payout, the displaying section corresponding to the paid-out jackpot displays the initial JP value.

When a player plays a slot game in the gaming machine 1 configured of the display 20 and the stations 4 in each of which the foregoing game screen 61 is displayed, the player makes a bet by operating at least one of the unit BET buttons 65, and subsequently presses the start button 46 in accordance with an instruction displayed on the message displaying section 64, as in the case of the conventional slot machine. In the bet operation, each time the player touches one of the unit BET buttons 65: a 1-credit BET button 65A, a 5-credit BET button 65B, a 10-credit BET button 65C and a 100-credit BET button 65D, a unit of credits corresponding to the touched unit BET button 65 are bet. For example, when the player touches the 10-credit BET button 65C four times, the 5-credit BET button 65B once and the 1-credit BET button 65A three times, a total of 48 credits are bet.

Once the player presses the start button 46 after making a bet operation through the aforementioned game screen 61, the primary game is carried out in which the 15 symbols displayed on the symbol displaying region 62 are scrolled vertically, are subsequently stopped automatically after a period of time, and thereby the symbols are rearranged. FIG. 1 shows an example of the game screen 61 displaying the symbols rearranged as an outcome of a primary game.

The timings of completions of symbol rearrangements are synchronized among all the stations 4 by using following methods: prompting each player to make a bet operation with a prompting display on the message displaying section 64; setting up a time limit before which each player can make a bet operation; and causing the control device 13 to adjust a period of time from when the symbols start to be scrolled till when the symbols are stopped in each of the stations 4. In other words, even though times when the symbols start to be scrolled are different among all the participating stations 4 because times when the symbols start to be scrolled depend on timings at which the players make their bet operations, press their start buttons and the like, the aforementioned controls make it possible to synchronize timings when the symbols are stopped among all the participating stations 4.

Once the primary games are completed in all the participating stations 4, the gaming machine 1 causes the control device 13 to start a horse racing game as a shared game shared by all the participating stations 4 (termed as a secondary game) on the display 20. The display panel 20a in the display 20 shown in FIG. 1 displays an outcome of the secondary game. The “HORSE” symbols sampled in this shared game are reflected on all the participating stations 4. As shown in the game screen 61 in the lower half of FIG. 1, the “HORSE” symbols thus sampled are displayed on the secondary game outcome displaying section 63, and are incorporated with the outcome of the slot game carried out in each of the participating stations 4 to determine a final combination.

A payout is provided on the basis of a relationship between the outcomes of the primary and secondary games. For example, when the horse finishing first in the secondary game carried out on the display 20 matches the “HORSE” symbol included in the symbol combination formed as the outcome of the primary game, a payout corresponding to the combination formed as the outcome of the primary game becomes even higher. Alternatively, the “HORSE” symbols corresponding to the horses appearing in the secondary game may be used as what are termed as scatter symbols. In this case, when the first to third finishing “HORSE” symbols are rearranged in any of the 3×5 sub-regions of the symbol displaying region 62 as an outcome of the primary game, a payout corresponding to this rearrangement may be provided.

As shown in FIG. 1, the first finishing horse displayed on the display panel 20a corresponds to a “HORSE” symbol on a secondary game outcome displaying section 63a; the second finishing horse displayed on the display 20a corresponds to a “HORSE” symbol on the secondary game outcome displaying section 63b; and the third finishing horse displayed on the display 20a corresponds to a “HORSE” symbol on the secondary game outcome displaying section 63c. In each participating station 4, a payout to the player is determined on the basis of the symbols sampled in the secondary game. Specifically, in the slot game described by use of FIG. 1, the rearranged symbols, for example, in the Y line in the symbol displaying region 62 does not form a combination entitled to a payout when the primary game is completed. However, after the secondary game is completed, by applying a “HEART” symbol combined with the first finishing “HORSE” symbol and a “DIAMOND” symbol combined with the finishing second “HORSE” symbol to the symbols rearranged as the outcome of the primary game, a combination entitled to a payout is formed in the same Y line of the outcome of the primary game. In the present invention, as described above, a payout is provided according to the outcomes of the primary and secondary games. Detailed descriptions will be given of the horse racing game later.

As described above, in the gaming machine 1 shown as the embodiment of the present invention, each of the participating station 4 provides a payout on the basis of both a symbol combination temporarily determined in a primary game carried out by the station 4 itself and an outcome of a secondary game carried out by the control device 13 connected to all the stations 4. This makes it possible to incorporate excellent entertainment features of the stand-alone type gaming device with a simultaneous multiplayer game (mass game), and thereby to adding new entertainment features to the simultaneous multiplayer game.

In the present embodiment, as an example of a rearrangement, descriptions are given of the case where the 15 symbol displaying sub-regions 62aX to 62eZ are organized into columns each consisting of three sub-regions X to Z, and the symbols in the columns are scrolled vertically. However, the symbols may be individually changed in each of the 15 symbol displaying sub-regions 62aX to 62eZ.

Detailed descriptions will be given hereinbelow of the gaming machine which is shown as the embodiment of the present invention by use of the drawings.

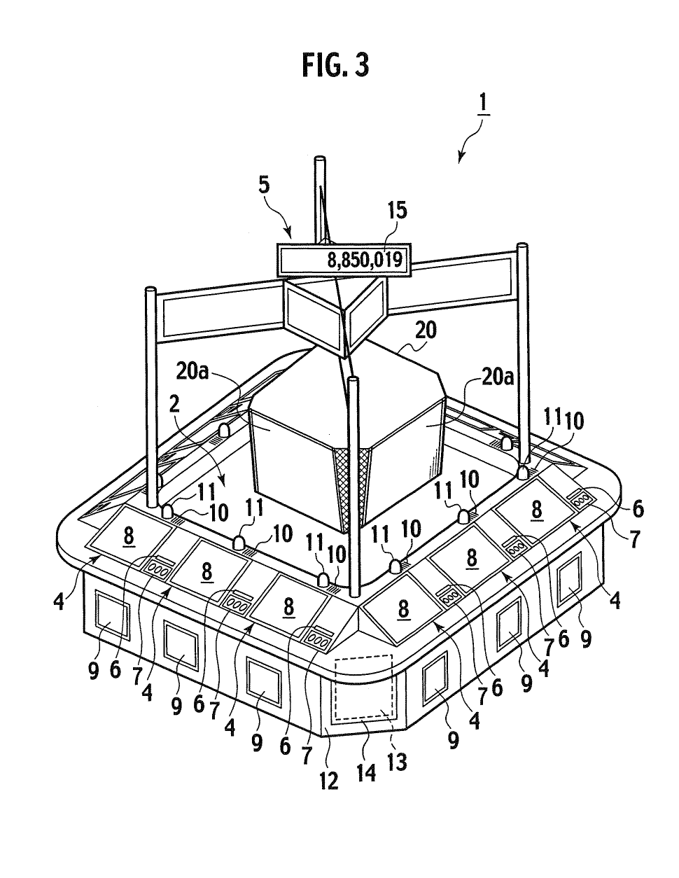

Descriptions will be given of a schematic configuration of the gaming machine 1 according to the present embodiment by use of FIGS. 2 and 3. As shown in FIG. 2, the gaming machine 1 is configured chiefly of the stations 4, the display 20 and the control device 13 configured to control the entire system including the stations 4 and the display 20. In the case of the present embodiment, the stations 4 are gaming devices in each of which a player can play a game. In the game, when multiple symbols having their own attributes which are different from one to another are changed and subsequently stopped, and then a payout (an award) is provided on the basis of the combination in the thus stopped symbols. As shown in FIG. 3, the gaming machine 1 is further provided with the large display 20. The display 20 is provided with the display panels 20a respectively in its four sides. Each display panel 20a displays an effect image of the shared game in which a predetermined symbol is sampled from multiple symbols used in the games carried out on stations 4, as described in detail later. The control device 13 chiefly carries out the shared game (secondary game), and also functions for controlling the entire gaming machine. The secondary game is displayed on the display 20.

Descriptions will be subsequently given of a configuration of the gaming machine 1. As shown in FIG. 3, the gaming machine 1 includes: a cabinet 2, the display 20, multiple (12 in the case of the present embodiment) stations 4, and an electric sign section 5. The cabinet 2 serves as a main body. The display 20 is provided on a substantially central part on the cabinet 20. The multiple stations 4 are provided around the display 20 in a manner of surrounding the display 20. The electric sign section 5 is provided above the cabinet 52. The stations 4 and the display 20 are electrically connected to the control device 13. In the present embodiment, the stations 4 share a part of their games in the entire gaming machine 1 within which the stations 4 are connected through a network 30. Instead, however, games of rearranging symbols may be designed to be played in the respective stations 4 in a stand-alone manner. Moreover, the gaming machine 1 may be connected to another gaming system with a configuration similar to that of the gaming machine 1 through a wireless or wired network.

Each station 4 at least includes: a medal insertion slot 6, a control section 7, and the display device 8. From the medal insertion slot 6, coins as well as gaming media each having a currency value, such as chips and medals, are inserted. The control section 7 includes multiple control buttons and the like through which the player inputs predetermined instructions. The display device 8 displays images on the game. Each station 4 accepts a bet operation made by a player. The player can continue playing the evolving game by operating the touch panel, the control section 7 and the like while watching the images displayed on the display device 8. Medal payout openings 9 are provided to each side of the cabinet 2, stations 4 being arranged in each side. In addition, a speaker 10 for reproducing music, effect sounds and the like is provided in the right above the display device in each of the stations 4.

Above the display device 8 in each of the stations 4, a win lamp 11 is provided. When a payout is determined on the basis of a combination of symbols during a game of rearranging symbols, the win lamp 11 is lit up in the station 4 in which the player plays the game and in which the payout is to be provided. In addition, when a player wins a jackpot on the basis of the player' s hand rank, the win lamp 11 is lit up in the station 4 in which the player plays the game.

Incidentally, each win lamp 11 is provided in a location visible from all the stations 4 (the 12 stations in the case of the present embodiment) arranged around the gaming machine 1. Accordingly, when a win lamp 11 of one of the stations 4 is lit up, all the other players playing in the same gaming machine 1 can see the win lamp 11 any time.

A medal sensor (not illustrated) is provided inside each of the medal insertion slots 6. The medal sensor validates the gaming media having currency value such as a medal or the like which is inserted from the medal insertion slot 6, and counts the amount of thus inserted gaming media. Furthermore, a hopper (not illustrated) is provided inside each of the medal payout openings 9. A predetermined amount of gaming media is paid out from the medal payout opening 9.

Inside a corner section 12 located in a corner of the cabinet 2, the control device 13 serving as the server for controlling progress of entire game situation in the gaming machine 1 is placed. The control device 13 is usually housed in the corner section 12 lest the control device 13 should be manipulated by players, and is operable by opening the corner door 14 provided to the corner section 12 by use of the key switch. Various settings can be made for the gaming machine 1 by operating the control device 13.

The electric sign section 5 is provided with a JP amount displaying section 15 on which an amount of a JP is displayed. As described later, the gaming machine 1 according to the present embodiment is designed to offer the three types of jackpot: “MEGA,” “MAJOR” and “MINI.” Credits equivalent to an accumulated amount of 0.15% of the total credits bet for JPs in all the 12 stations 4 are stored for a JP “MEGA.” Credits equivalent to an accumulated amount of 0.20% of the total credits bet for JPs in all the 12 stations 4 are stored for a JP “MAJOR.” Credits equivalent to an accumulated amount of 0.30% of the total credits bet for JPs in all the 12 stations 4 are stored for a JP “MINI.”

When one of the JPs, for example “MEGA,” is determined to be won in any of the participating stations 4 on the basis of the symbol combinations, the credits equivalent to the amount of credits accumulated for the JP “MEGA” are paid out to the awarded station 4. The JP amount displaying section 15 displays the credits accumulated for the JP “MEGA” out of the three types of JPs. Incidentally, the JP amount displaying section 15 is provided to the top section of the electric sign board 5, and accordingly the contents displayed thereon are visible to all the players playing games in their respective stations 4.

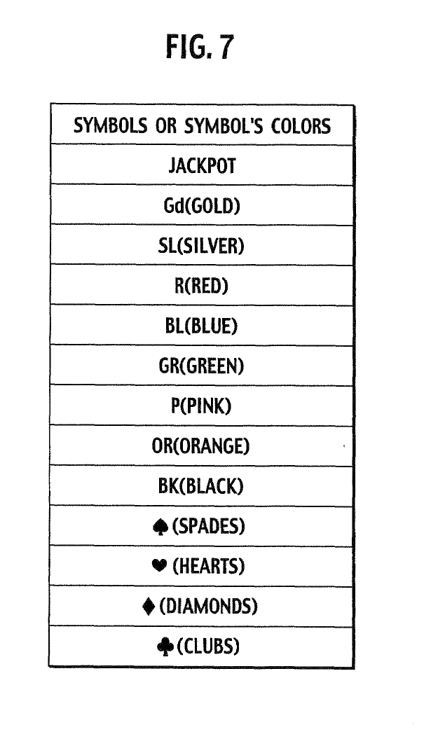

Once the “rearrangement” operations of changing and then stopping the symbols are completed in all the participating stations 4, the control device 13 receives a signal indicating the completion from each of the participating stations 4, and subsequently starts the shared game (secondary game) shared by all the participating stations 4. In the shared game, predetermined symbols are sampled from multiple symbols (detailed descriptions will be given of the symbols later) inclusive of the symbols used in the participating stations 4. In the present embodiment, as shown in FIG. 7, “HORSE” symbols having different colors, “SPADE” symbol, “HEART” symbol, “DIAMOND” symbol and “CLUB” symbol are provided as the symbols for a primary game carried out in each of the stations 4. In FIG. 7, “Gd” stands for gold; “SL,” silver; “R,” red; “BL,” blue; “GR,” green; “P,” pink; “OR,” orange; and “BK,” black.

In addition, as the symbols for the secondary symbols, symbols shown as FIG. 8, which are obtained by appropriately combining the foregoing symbols together, are stored in a RAM 83 and the like. The control device 13 carries out the secondary game in which a “HORSE” symbol is sampled from those shown in FIG. 8. This secondary game is carried out as a horse racing game in which the horses having different colors race for a higher rankings, and is displayed on the display 20. Detailed descriptions will be given of the secondary game later.

FIG. 8 shows examples of the symbols used in the secondary game. FIG. 8 shows images representing “HORSE” symbols having different colors, respectively. In the example shown in FIG. 8, the different colors are indicated by alphabet letters of “Gd,” “SL,” . . . ,stands for the respective colors for explanation purposes. In FIG. 8, the symbols are formed by combining “R” with “SPADE,” “BL” with “HEART,” “Gd” with “CLUB,” “P” with “DIAMOND,” “OR” with “SPADE,” “BK” with “HEART,” “GR” with “CLUB,” and “SL” with “DIAMOND.” The number shown in the upper left in each of the “HORSE” symbols stands for a gate number of the corresponding horse. Note that multiple different symbol combinations may be provided in addition to the examples illustrated in FIG. 8.

The display 20 is provided in a location visible to the players playing their games in their respective stations 4. The display 20 displays a series of processes in which the control device 13 samples symbols, along with effect images.

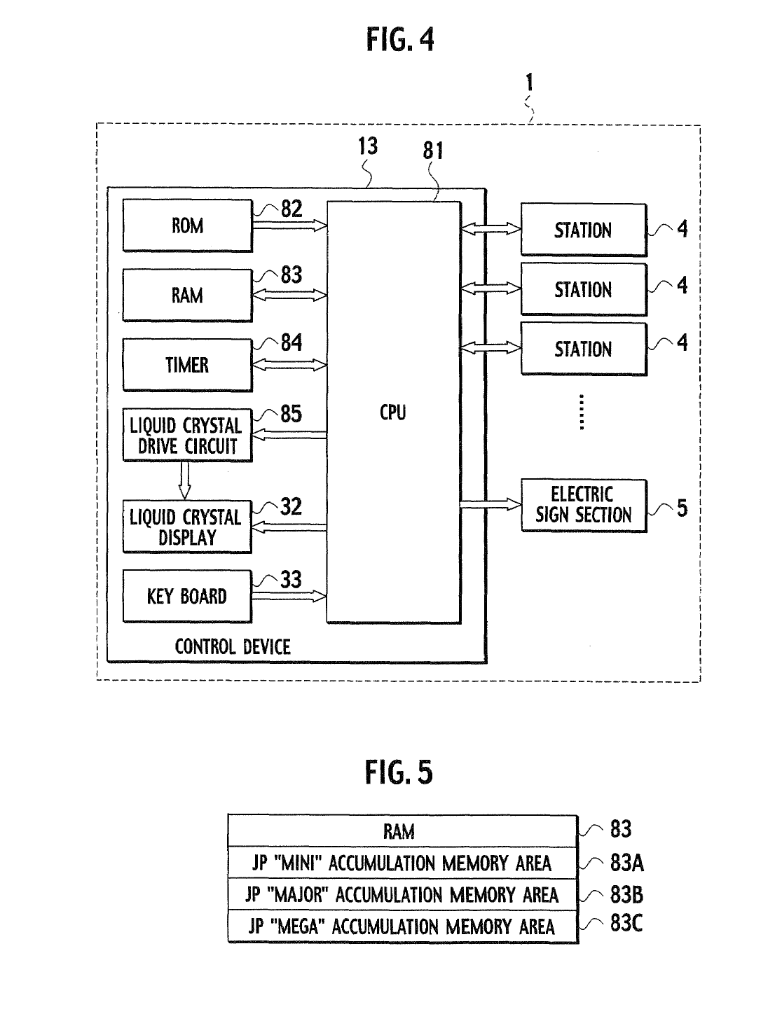

Next, descriptions will be given of an internal configuration of the gaming machine 1 shown as the embodiment of the present invention by use of FIG. 4. As shown in FIG. 4, the gaming machine 1 is configured of the control device 13 and the multiple stations 4 (the 12 stations in the present embodiment) connected to the control device 13. The electric sign section 5 is connected to the control device 13. Descriptions will be given of an internal configuration common among the stations 4 later.

The control device 13 includes a CPU 81 for controlling the entire system, a ROM 82, a RAM 83, a timer 84, a liquid crystal display 32 connected to the control device 13 via a liquid crystal drive circuit 8; and a keyboard 33. The control device 13 carries out a process for sampling predetermined ones from the symbols formed by combining the symbols shown in FIG. 7. In the present embodiment, the race rankings in the horse racing game are determined through the process.

The CPU 81 carries out various processes on the basis of input signals supplied from each of the stations 4 as well as data and programs stored in the ROM 82 and the RAM 83, and the like. On the basis of results of the processes, the CPU 81 transmits instruction signals to the stations 4, and thus controls the stations 4 in a leading manner. In particular, the CPU 81 receives signals from each of the stations 4, and thus carries out a series of processes for displaying effect images on the display 20.

In addition, the CPU 81 carries out the process for sampling the predetermined ones out of the symbols obtained by combining one of the “HORSE” symbols each having a different color with one of the symbols of “SPADE”, “HEART”, “DIAMOND” and “CLUB”. Specifically, the CPU 81 monitors whether primary games carried out in the respective stations 4 are completed. Upon receipt of a signal indicating the completion of the primary games, the CPU 81 starts a horse racing game as the secondary game, and gives an effect in which an outcome of a symbol selection is determined as race rankings of the horse racing. Note that, multiple combinations may be provided for one “HORSE” symbol, by combining one of the “HORSE” symbols with two or more of the symbols of “SPADE”, “HEART”, “DIAMOND” and “CLUB” one by one. Alternately, the combinations may be changed each time a secondary game is carried out.

An outcome of the secondary game carried out by the CPU 81 is transmitted to each of the participating stations 4, which calculates the amount of a payout by incorporating the outcome of the secondary game to the outcome of its primary game. Thereby, instead of causing the stations 4 to carry out a individual game in which the symbols are rearranged in a stand-alone manner, the gaming machine causes parts of the individual games which have carried out in the respective participating stations 4 to be shared and carried out as a shared game by use of the control device 13 and the display 20. Accordingly, the shared game is shared by all the participating stations 4.

The ROM 82 is configured, for example, of a semiconductor memory or the like. The ROM 82 stores a program for implementing basic functions of the gaming machine 1 in addition to a program for notifying maintenance timings as well as for executing the setting and management of the conditions for notifying maintenance timings, programs for controlling the stations 4 in the leading manner, and the like are stored in the ROM 82. Furthermore, the ROM 82 stores the “HORSE” symbols each having a different color with one of the symbols of “SPADE”, “HEART”, “DIAMOND” and “CLUB”.

Data on the amount of credits bet in each of the stations 4, data on the amounts respectively of the jackpots “MINI,” “MAJOR” and “MEGA”, and data on results of processes carried out by the CPU 81 are stored in the RAM 83.

FIG. 5 shows memory areas in the RAM in the gaming machine according to the present embodiment. As shown in FIG. 5, the RAM 83 is provided with: a JP “MINI” accumulation memory area 83A for storing the amount of credits accumulated for the JP “MINI”; a JP “MAJOR” accumulation memory area 83B for storing the amount of credits accumulated for the JP “MAJOR”; and a JP “MEGA” accumulation memory area 83C for storing the amount of credits accumulated for the JP “MEGA”.

Furthermore, the timer 84 for measuring a time period is connected to the CPU 81. Information on the time period measured by the timer 84 is transmitted to the CPU 81. On the basis of the information on the time period measured by the timer 84, the CPU 81 controls the effect process and the like.

Moreover, the electric sign section 5 (see FIGS. 3 and 4) is connected to the CPU 81. The CPU 81 gives an illumination effect by controlling light emissions of LEDs and the like. In addition, the CPU 81 causes predetermined characters and the like to be displayed on the electric sign section 5. Furthermore, the CPU 81 causes the credit amount for a JP so far accumulated (the credit amount for the JP “MEGA” in the case of the present embodiment) to be displayed.

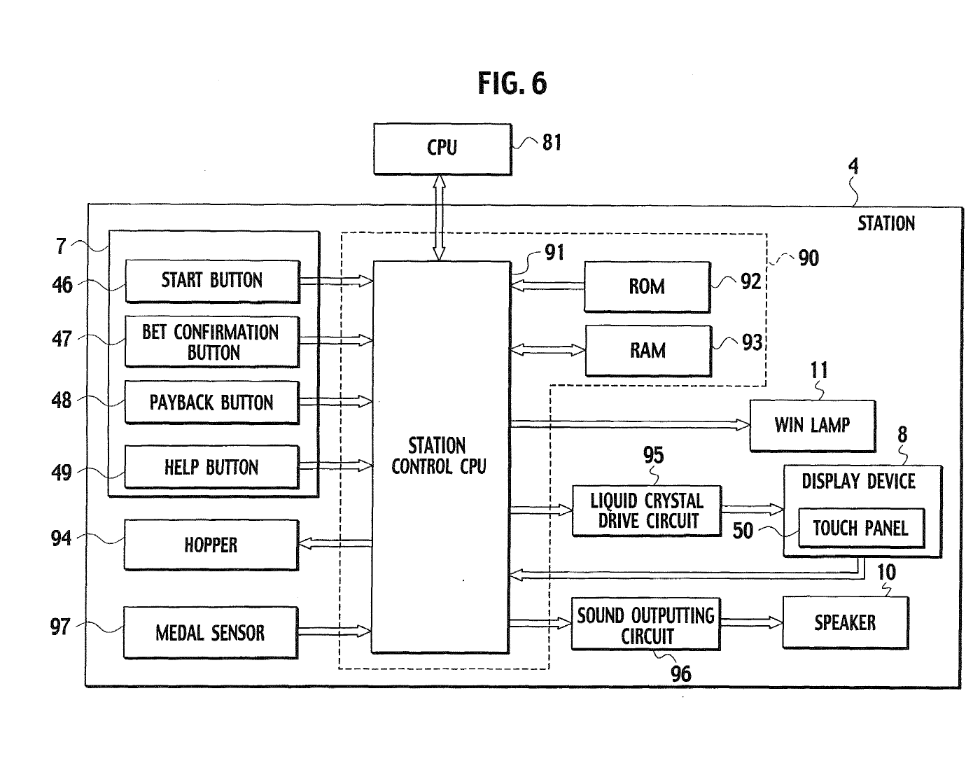

Subsequently, FIG. 6 shows an internal configuration common among the stations 4 constituting the gaming machine 1 shown as the embodiment of the present invention. In the case of the present embodiment, a single configuration is basically applicable to all the 12 stations 4. For this reason, description will be given of the internal configuration of one of the stations 4 as an example.

The station 4 includes: the display device 8 adapted to display images on “rearrangement” in a primary game in which the multiple symbols are changed and thereafter stopped; a transmit-receive interface (not illustrated) through which the station 4 transmits/receives control signals and the like to/from the CPU 81 in the control device 13; and the memory for storing data on images of the multiple symbols having their own attributes, including the symbols used in a primary game played in the station 4, a payout table for associating symbol combinations with payouts (described hereinafter), and the like. Upon receipt of a control signal through the transmit-receive interface, the station 4 samples pieces of image data stored in the memory, and displays the sampled pieces of image data, and carries out a process for providing a payout (an award) on the basis of a symbol combination formed by both an outcome of a primary game carried out by the station 4 itself and an outcome of a secondary game carried out by the control device 13 by referring to the payout table stored in the memory.

As shown in FIG. 6, the station 4 includes a station control unit configured of a station control CPU 91, a ROM 92 and a RAM 93. The ROM 92 is configured, for example, of a semiconductor memory. Programs for implementing basic functions of the station 4, other various programs needed for controlling the station 4, a data table and the like are stored in the ROM 92. An example of data stored in the ROM 92 is data on the images of the multiple symbols used in a primary game played in the station 4. Payout rates corresponding to winning symbol combinations formed in a primary game carried out by the station (the amounts of credits paid out per chip respectively for possible winning card combinations) are stored in the form of a table in the ROM 92 in the station 4. In other words, the ROM 92 functions as a payout memory.

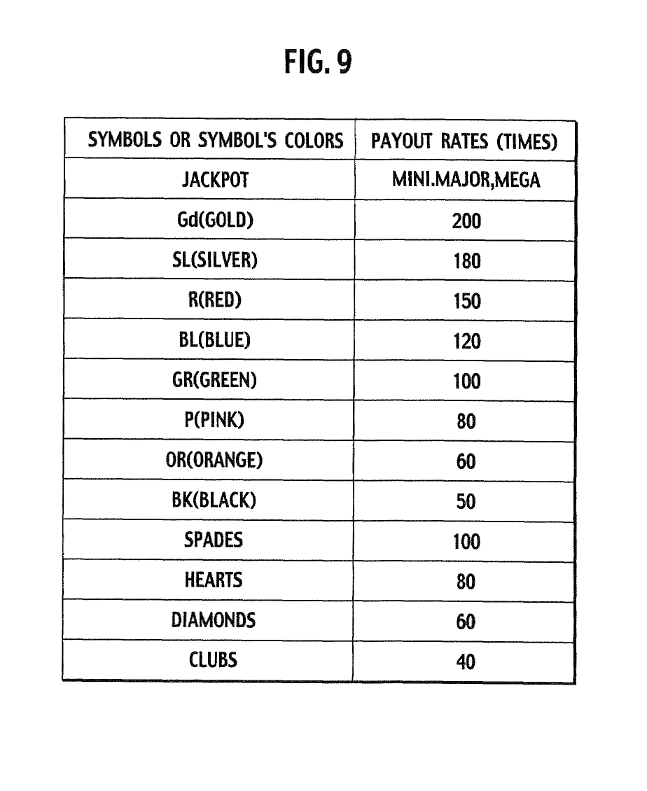

FIG. 9 shows an example of the payout table associating the combinations with the payout rates and stored in a ROM 92. FIG. 9 shows the payout rates per a bet of one credit for the respective symbol combinations. In the present embodiment, as an example of a combination entitled to a payout as shown in FIG. 9, when the same predetermined symbols are rearranged on one of the lines across the video reels, a payout is provided in an amount obtained by multiplying the bet made by the player by a predetermined payout rate. Specifically, the payout rates are set up as follows. When the “Gd HORSE” symbols are rearranged in one of the lines across the video reels, the payout rate is 200 times; the “SL HORSE” symbols, 180 times; the “R HORSE” symbols, 150 times; the “BL HORSE” symbols, 120 times; the “GR HORSE” symbols, 100 times; the “P HORSE” symbols, 80 times; the “OR HORSE” symbols, 60 times; and the “BK HORSE” symbols, 50 times. Note that these are only examples of the payout rates. The payout rates respectively corresponding to the combinations are not limited to those shown in FIG. 9.

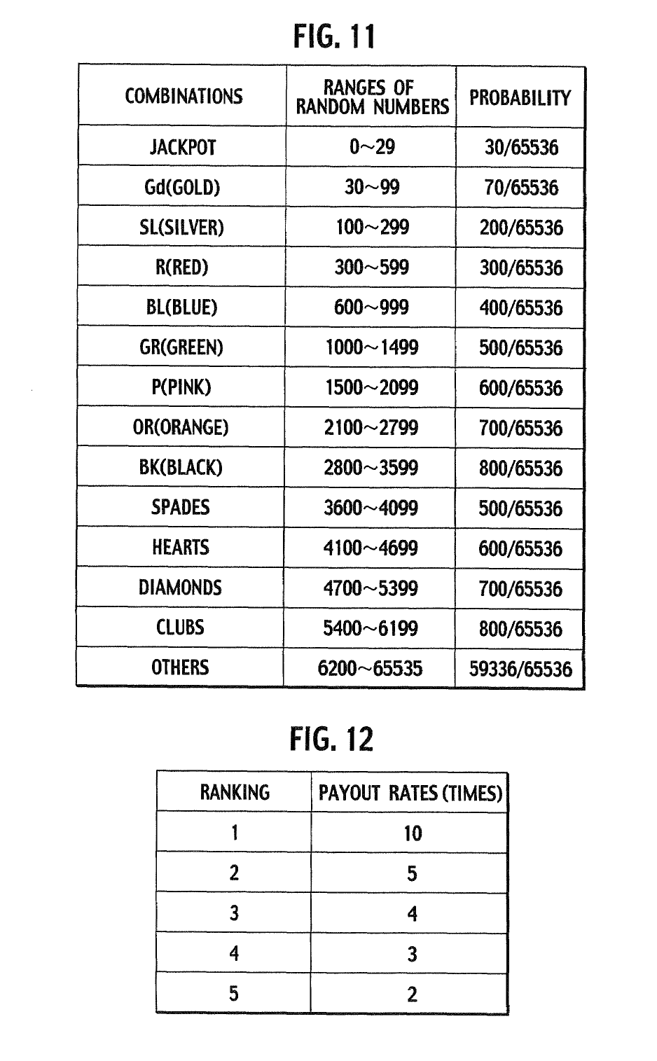

FIG. 11 shows a random number table for the primary game which is used to determine what symbols are rearranged after changing the symbols in the primary game in one of the participating stations 4. Ranges of random numbers and winning probabilities are associated with the particular combinations entitled to payouts and registered in this random number table for the primary game. FIG. 11 shows probabilities at which a combination consisting of JPs only, a combination of “Gd HORSE” symbols only, and so forth are formed on one of the lines such as X, Y and Z lines and the like, as examples of these combinations.

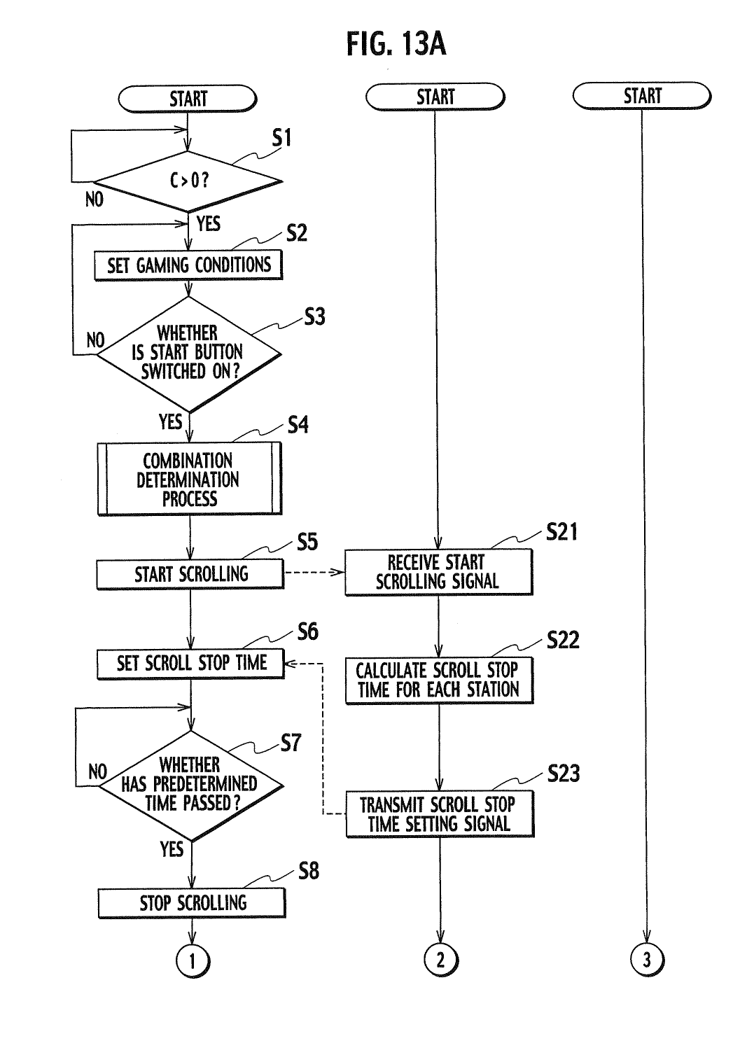

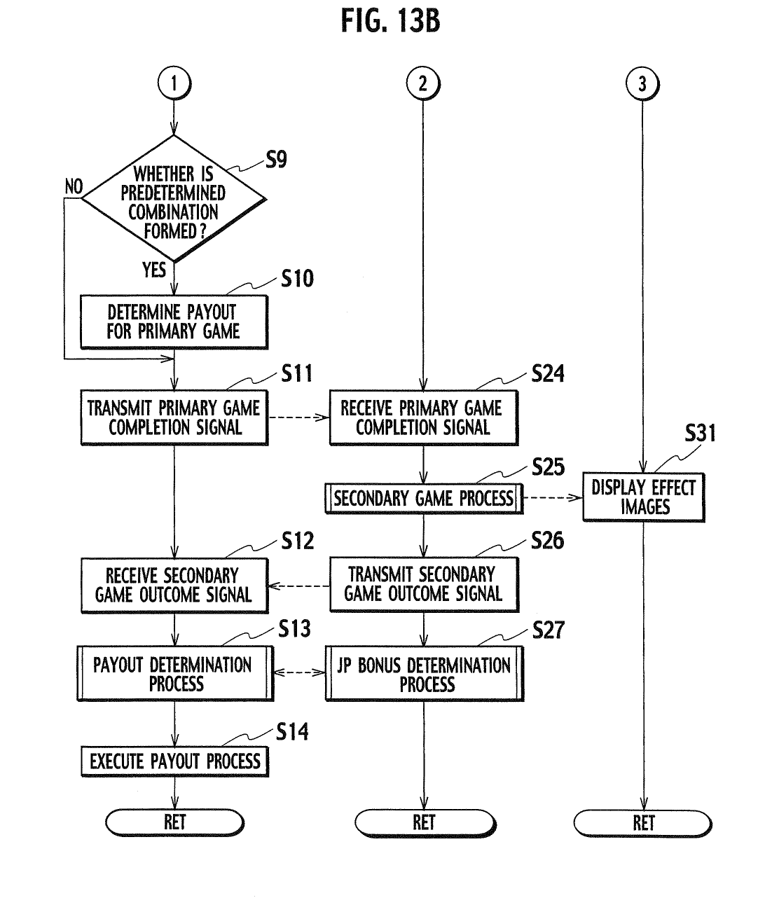

In a below-described combination determining process (step S4 in FIG. 13), when, for example, a random number within a range of “0” to “29” is sampled from the random numbers “0” to “65535,” it is determined in the station 4 that a particular combination for providing a jackpot (in which a jackpot symbol is stopped on each of sub-regions consisting one of the lines across the video reels) should be generated. In other words, a probability at which a JP is provided on the basis of the symbols thus stopped is “30/65536.” In addition, when, for example, a random number within a range of “30” to “99” is sampled from the random numbers “0” to “65535,” it is determined in the station 4 that a “Gd HORSE” symbol is stopped on each of sub-regions consisting one of the lines across the video reels as an outcome of the primary game. In other words, a probability at which a “Gd HORSE” symbol is determined to be stopped on each of sub-regions consisting one of the lines is 70/65536. Furthermore, when, for example, a random number within a range of “6200” to “65535” is sampled from the random numbers “0” to “65535”, it is determined in the station 4 that the player should lose as an outcome of the primary game. In other words, a probability at which the stopped symbols are determined to form a losing combination on all the lines is 59336/65536. Note that the random number table shown in FIG. 11 is only an example of a random number table used for the present embodiment and thus that the random number table can be appropriately changed.

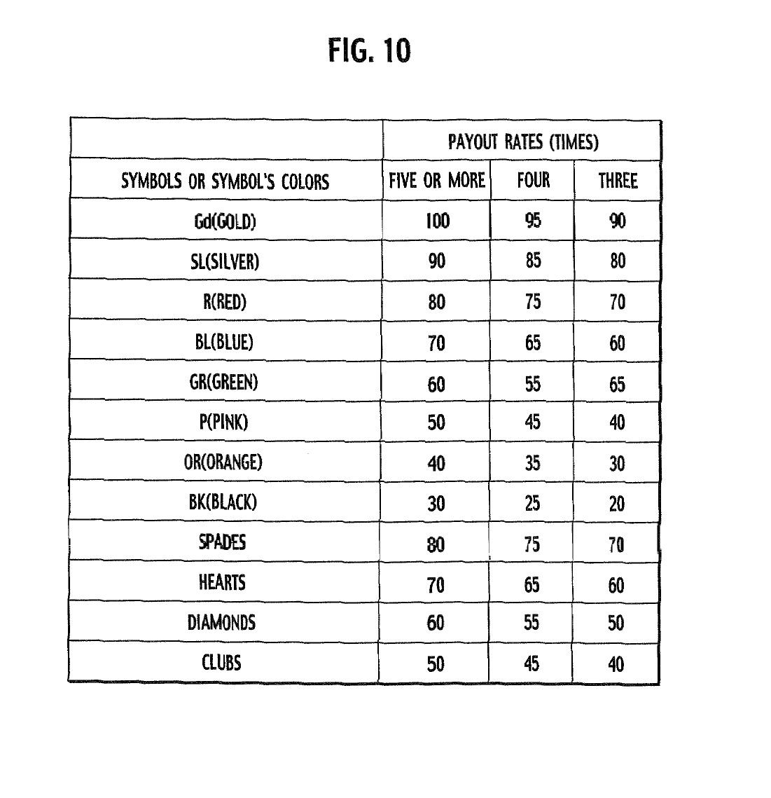

Moreover, in the embodiment, so-called scatter symbols may be employed. The scatter symbols are not same symbols arranged on one of the lines across the video reels, but a predetermined number of same symbols displayed on the screen displaying the video reels, regardless of whether or not the symbols are respectively stopped on sub-regions including all the sub-regions consisting any of the lines, after changing and stopping all the symbols displayed on the screen. When a predetermined number of the scatter symbols appear on the screen, a payout is provided. In the present embodiment, payout rates applied to 5, 4 and 3 scatter symbols are determined in accordance with a payout table shown in FIG. 10, for example. In the present embodiment, when predetermined symbols in a number determined in the table shown in FIG. 10 appear in the symbol displaying region 62 as an outcome of the primary game, a corresponding payout is provided. If, for example, five or more “Gd HORSE” symbols appear as the scatter symbols, 100 credits per a credit bet by the player are paid out.

The RAM 93 is used as a work area for the station control CPU 91. The RAM 93 is a memory in which various pieces of data on which the station control CPU 91 does arithmetic, the amount of credits currently possessed by the player, the amount of credits accumulated in the entire gaming machine 1, the status in which the player makes a bet, and the like are stored.

The station control CPU 91 controls the game in which, in accordance with the random number table, predetermined symbols are sampled from the multiple symbols having their own attributes different from one to another, which are stored in the ROM 92, and a payout is provided on the basis of a combination created from the symbols thus sampled. In addition, the station control CPU 91 provides a payout on the basis of a relationship between a symbol combination determined by the station control CPU 91 itself for the primary game and an outcome of the secondary game as the shared game with reference to the payout tables (see FIGS. 9 and 10) stored in the ROM 92.

Furthermore, the station control CPU 91 changes the amount of payout made by the station 4 on the basis of symbols sampled by the control device 13, that is, on an outcome of the secondary game. FIG. 12 shows a table in which payout rates are determined on the basis of the placing of the racing horses. Specifically, if a horse represented by a single symbol forming a combination in the primary game reaches the goal with the placing shown in the table, a payout is given on the basis of a corresponding payout rate. For example, if the “Gd HORSE” symbol is rearranged (in the sub-regions 62aY, 62bY, 62cY, 62dY and 62eY) in the Y line in the primary game, and in the Gd horse reaches the goal first in the secondary game, the number of credit paid out in the primary game is 200 times as many as the number of credit bet on the game (see FIG. 9). In addition, the amount of credits paid out in the primary game is multiplied by 10 on the basis of the race rankings of horses in the secondary game (see FIG. 12). As a result, the player can receive 2000 credits per a credit bet by the player.

The start button 46, a bet confirmation button 47, a payback button 48 and a help button 49, which are provided in the control section 7 (see FIG. 3), are electrically connected to the station control CPU 91.

The start button 46 is that which the player operates for starting the changing of the symbols displayed in the symbol displaying region on the display device 8 after making a bet operation. Once the player operates the start button 46, the symbols displayed in the symbol displaying region 62 having 5 columns ×3 rows start to be scrolled vertically as if the reels revolved, and subsequently stop.

The bet confirmation button 47 is a button which a player presses down when the player confirms a bet after operating the bet operation. The payback button 48 is a button which the player usually presses down when the game is over. Once the payback button 48 is pressed down, medals are paid back to the player through the medal payout opening 9 on the basis of credits currently possessed by the player, and which have been earned by the player through the game and the like. The help button 49 is a button which the player presses down when the player does not know how to operate the station for continuing to play the game. Once the help button 49 is pressed down, a help screen for showing information on various operations is immediately displayed on the display device 8.

On the basis of operation signals outputted when the buttons are pressed down, the station control CPU 91 controls the station in order to implement various operations correspondingly. Specifically, when an operation of the player is inputted, the station control CPU 91 carries out a corresponding process on the basis of an input signal supplied from the control section 7 as well as the data, the programs and the like which are stored in the ROM 92 and the RAM 93. Thereafter, the station control CPU 91 transmits a result of the process to the CPU 81.

In addition, the station control CPU 91 receives an instruction signal from the CPU 81, and thus controls the peripheral devices constituting the station 4, hence controlling progress of the primary game played in the station 4. Furthermore, when an operation of the player is inputted, the station control CPU 91 carries out a corresponding process on the basis of an input signal supplied from the control section 7 as well as the data, the programs and the like which are stored in the ROM 92 and the RAM 93. On the basis of a result of the process, the station control CPU 91 controls the peripheral devices constituting the station 4, and thus continues the game.

A hopper 94 is connected to the station control CPU 91. On the basis of an instruction signal from the station control CPU 91, the hopper 94 pays out a predetermined number amount of medals through the medal payout opening 9 (see FIG. 3). The display device 8 is electrically connected to the station control CPU 91 with a liquid crystal drive circuit 95 in between. The display device 8 is controlled by the station control CPU 91, and thus displays a series of pieces of information on the game to the player.

The liquid crystal drive circuit 95 includes a program ROM, an image ROM, an image controlling CPU, a work RAM, a VDP (Video Display Processor) and a video RAM. Programs for controlling images to be displayed on the display device 8 and various selection tables are stored in the program ROM. For example, dot data for forming the images to be displayed on the display device 8 is stored in the image ROM. On the basis of a parameter set up in the station control CPU 91, the image control CPU selects an image to be displayed on the display device 8 from the dot data beforehand stored in the image ROM in accordance with the image control programs beforehand stored in the program ROM. The work RAM is a temporary storage in which the image control programs are stored when the image control programs are executed by the image control CPU. The VDP forms images corresponding to the contents of a display selected by the image control CPU, and thus outputs the images to the display device 8. Incidentally, the video RAM is a temporary storage which is used when the VDP forms the images.

As described above, the touch panel 50 is attached to the front surface of the display device 8. Information generated by operating the touch panel is transmitted to the station control CPU 91. The player can make a bet operation by use of the game screen 61 displayed on the touch panel 50. Specifically, the player can make operations for doing things such as starting to play a game and determining the amount of credits to be bet by touching the unit BET buttons 65. Information generated by the operations is transmitted to the station control CPU 91. On the basis of the information, the amount of chips which the player currently bet is stored in the RAM 93 each time the player bets the chips through the game screen 61. Furthermore, information on the completion of the primary game as well as information on bets is transmitted to the CPU 81 in the control device 13, and subsequently is stored in the memory area in the RAM 83 in the control device 13.

A sound outputting circuit 96 and a speaker 10 are also electrically connected to the station control CPU 91. The speaker 10 gives out various effect sounds when various effects are given on the basis of output signals from the sound outputting circuit 96.

The medal sensor 97 is also electrically connected to the station control CPU 91. The medal sensor 97 detects medals put in through the medal insertion slot 6 (see FIG. 3), and do arithmetic on the medals thus put in, hence transmitting the arithmetic result to the station control CPU 91. On the basis of the transmitted signals, the station control CPU 91 increases the amount of credits possessed by the player, which amount is stored in the RAM 93.

The win lamp 11 is also electrically connected to the station control CPU 91. The station control CPU 91 flashes the win lamp 11 on and off in a predetermined color in a case where the player wins a card game on which the player bets through the game screen 61, or in a case where the player wins a JP.

Because the station 4 has the foregoing configuration, the station 4 is capable of carrying out the primary game in which the multiple symbols are changed and stopped in the display device 8, and the amount of payout is determined on the basis of whether or not any one of the predetermined combination is formed.

Subsequently, by use of FIGS. 13A and 13B, descriptions will be provided for a gaming process carried out by the station control CPU 91 in a corresponding one of the stations 4 for the primary game, and a gaming process carried out by the CPU 81 in the control device 13 for the secondary game, the stations 4 and the control device 13 constituting the gaming machine 1 as shown as the embodiment of the present invention.

First of all, descriptions will be provided for the gaming process carried in each of the stations 4 in the gaming machine 1. The gaming machine 1 includes the multiple stations 4. The gaming process carried out in each of the stations 4 is as follows.

To begin with, the station control CPU 91 in the station 4 determines whether or not there remain credits (step S1), the amount of remaining credit being equal to the number of coins which remain out of coins put in by the player. Specifically, the station control CPU 91 reads the amount C of credits stored in the RAM 93, and executes the process on the basis of the amount C of credits thus read. When the amount of credits is zero (if NO in step S1), the station control CPU 91 terminates the routine without executing the process, because no game can be started. On the other hand, if the amount C of credits is one or more (if YES in step S1), the station control CPU 1 determines that there remain credits, and proceeds to step S2.

In step S2, the station control CPU 91 sets up conditions for the game. Specifically, the station control CPU 91 receives an operation of the unit BET button 65. On the basis of this input, the station control CPU 91 set up the amount of credit bet on the slot game as the primary game. At this time, the station control CPU 91 receives an operation signal generated by the operation of the unit BET button 65. On the basis of the received operation signal, the station control CPU 91 cause the amount of credits bet on the slot game in a predetermined memory area. The station control CPU 91 reads the amount C of credits written in another predetermined memory area, and subtracts the amount of bet credits from the amount C of credits thus read, hence causing a number obtained by this subtraction to be stored in a predetermined memory area. Subsequently, the station control CPU 91 proceeds to step S3.

In step S3, the station control CPU 91 determines whether or not the start button 46 is operated. If the station control CPU 91 receives an operation signal from the start button 46 (if YES in step S3), the station control CPU 91 proceeds to step S4. If the station control CPU 91 receives no operation signal from the start button 46 before the predetermined time period is over (if NO in step 3), the station control CPU 91 determines that the start button 46 is not pressed yet, and returns to step S2.

In step S4, the station control 91 executes a combination determining process. For this combination determining process, the station control CPU 91 determines what symbols are stopped to form a combination on a line (hereinafter referred to as a “pay line”) on which any one of predetermined symbols needs to be rearranged across all the reels if a payout is going to be made. Specifically, the station control CPU 91 generates a random number in a predetermined range (“0” to “65535” in the present embodiment), and causes the generated random number to be stored in a predetermined memory area in the RAM 93. In the present embodiment, the random number is generated by the station control CPU 91 doing arithmetic. It should be noted, however, that the random number may be generated by a random number generator provided outside the station control CPU 91.

The station control CPU 91 reads the random number table for the primary table (see FIG. 11) and a table (not shown) indicating the combinations entitled to payouts, which are stored in the ROM 92. Thereafter, the control station CPU 91 causes the tables thus read to be stored in predetermined memory areas in the RAM 93. The station control CPU 91 reads the random number table for the primary game and the table determining particular combinations set up for providing payouts, which are stored in the predetermined memory areas in the RAM 93, and thus determines a symbol combination which is going to be rearranged on the pay line by checking the generated random number against the random number table.

Subsequently, in step 5, the station control CPU 91 starts to scroll the symbols in the symbol displaying region 62, and transmits a signal indicating the start of the scroll to the control device 13. In step S6, the station control CPU 91 receives from the control device 13 a signal for setting up a time period which should pass before the scroll is stopped, and thus sets up the time period up to the stop.

In step S7, the station control CPU 91 determines whether or not the predetermined time period set up in step S6 passes. If the predetermined time period passes (if YES in step S7), the station control CPU 91 proceeds to step S8, where the station control CPU 91 stops the scroll, and thus rearranges the symbols in a way that the combination set up in step S4 shows up.

Once the station control CPU 91 determines the symbol combination which is going to be rearranged on the pay line, the station control CPU 91 determines, in step S9, whether or not the symbol combination on the pay line is any one of the combinations entitled to payouts. If, as an outcome of the primary game, any one of the combinations entitled to payouts is created (if YES in step S9), the station control CPU 91 temporarily determines a payout for the primary game in step S10, and subsequently transmits a signal indicating the completion of the primary game to the control device 13 in step S11. On the other hand, if, as an outcome of the primary game, no combination entitled to a payout is not created (if NO in step 9), the station control CPU 91 proceeds to step S11, where the station control CPU 91 transmits a signal indicating the completion of the primary game to the control device 13.

Thereafter, once the station control CPU 91 receives data indicating an outcome of the secondary game from the control device 13 in step S12, the station control CPU 91 executes the payout determination process in step S13. For the payout determination process, upon reception of the outcome of the secondary game, the station control CPU 91 does things such as changing the payout rate on the basis of the race rankings of horses, and calculating the payout on the basis of the new condition. In addition, the station control CPU 91 transmits the outcomes of the primary and secondary games to the control device 13. The control device 13 determines whether or not the combination created at this time is a combination entitled to any one of the JP bonuses “MINI,” “MAJOR” and “MEGA,” and transmit a notice indicating the entitlement to the JP bonus to a station 4 entitled to the JP bonus. In the station 4, in step S14, the station control CPU 91 finally provides a payout in relation to the outcomes of the primary and secondary games on the basis of the result of the determination made on the JP bonus and the result of the payout determination process executed in step S13.

Subsequently, descriptions will be provided for the gaming process carried out by the control device 13 in the gaming machine 1 by use of FIGS. 13A and 13B.

After, in step S21, the CPU 81 in the control device 13 receives the scroll start signal transmitted from each participating station 4 in step S5, the CPU 81 calculates the scroll time period for each participating station 4 in step S22, and transmits a signal indicating the time period up to the stopping of the scroll to the station 4.

Usually, the slot games doe not start simultaneously, because the players do things such as making their bet operations in their stations 4 at mutually deferent times. However, the CPU 81 is capable of causing all the participating stations 4 to stop their scrolls simultaneously. This is because, in each participating station 4, the scroll time period is set up on the basis of the signal indicating the time period up to the stopping of the scroll, the scroll ends in the time period thus set up, and the symbols stop with a predetermined combination.

Subsequently, in step S24, the CPU 81 in the control device 13 receives the signal indicating the completion of the primary game (in step S11) from each participating station 4. In step S25, the CPU 81 starts the secondary game. At this time, the CPU 81 transmits a control signal for displaying the effect image on the display 20. Thereafter, in step S26, the CPU 91 transmits the outcome of the secondary game to all the participating stations 4. Each participating station 4 carries out the payout determination process upon receipt of the date on the outcome of the secondary game, and transmits the result of the payout determination process to the control device 13.

In the control device 13, in step S27, on the basis of the result of the payout determination which is transmitted from each participating station 4, the CPU 81 determines whether or not there is a station 4 in which any one of the combinations entitled to one of the JP bonuses “MINI,” “MAJOR” and “MEGA” is created. In step S27, the CPU 81 transmits to an entitled station 4 the signal indicating the entitlement to the JP bonus. The entitle station 4 provides a payout on the basis of the result of the determination made on the JP bonus and the result of the payout determination process executed in step S13.

The display 20 displays the effect image on the basis of the control signal transmitted from the control device 13 at the timing corresponding to step S25 (in step 31).

Detailed descriptions will be provided hereinbelow for the progress of the slot game carried out on the foregoing process shown in FIGS. 13A and 13B by use of examples of a display for the secondary game which is displayed both on the game screen 61 displayed on the display device 8 in each participating station 4 and on the display panels 20a in the display 20.

FIG. 14 shows an example of a screen which is displayed on the game screen 61 while the station 4 is waiting for the slot game as the primary game to be started. On the game screen 61, a character image of “You can Start a Game by Pressing the Start Button” is displayed in the message displaying section 64. Furthermore, “512” is displayed in the credit amount displaying section 67. In other words, this number indicates that the amount of credits possessed by the player is 512 while the game screen is displaying the number. Once the player presses the start button 46, the primary game is started in the station 4. Although illustrated in FIG. 14, a symbol combination as a result of the previous primary game is displayed in the symbol displaying region 62.

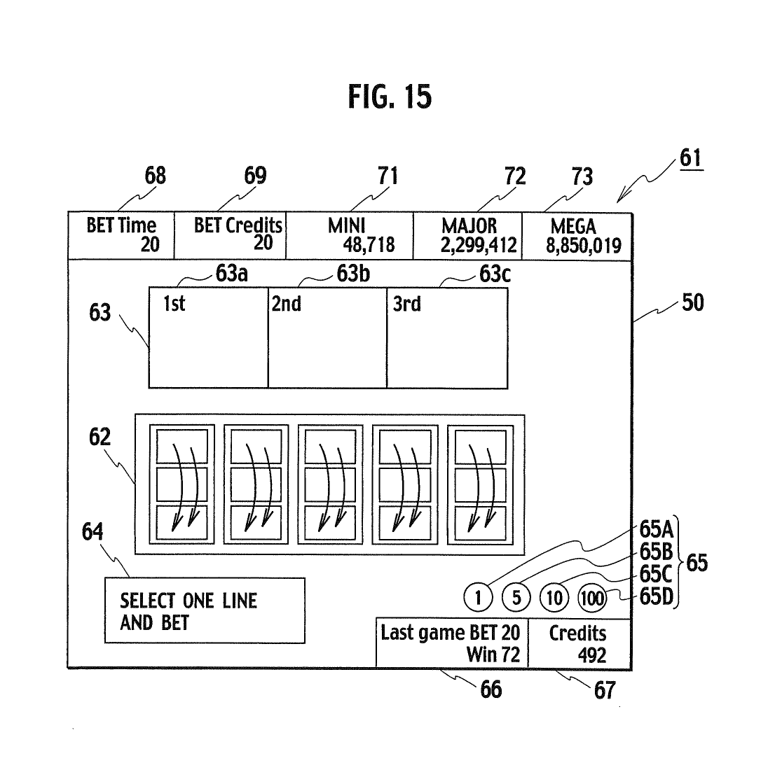

Once the player presses the start button 46, the game screen 61 shown in FIG. 15 is displayed on the display device 8. Specifically, by indicating one line and operating the unit BET button 65 in accordance with the foregoing procedure, the player can make a bet on the indicated line. The game screen 61 illustrated in FIG. 15 shows how the symbols are scrolled in the symbol displaying region 62. In this respect, the scroll is designed to be started after a rearranged combination is decided inside the station 4, and to be stopped automatically at the stop time calculated in the control device 13 (in steps S4 to S7).

Moreover, as shown in FIG. 15, the symbols are scrolled in the symbol displaying region 62, and a character image of “Select One Line and Bet” is displayed in the message displaying section 64. In addition, it is displayed in the credit amount displaying section 67 that the amount of credits reduces to 492 when the player bets 20 credits on the slot game before the bet-allowable remaining time reduces to zero. The control device 13 accumulates credits for the JPs “MINI,” “MAJOR” and “MEGA” on the basis of the allocation ratios for the respective JPs.

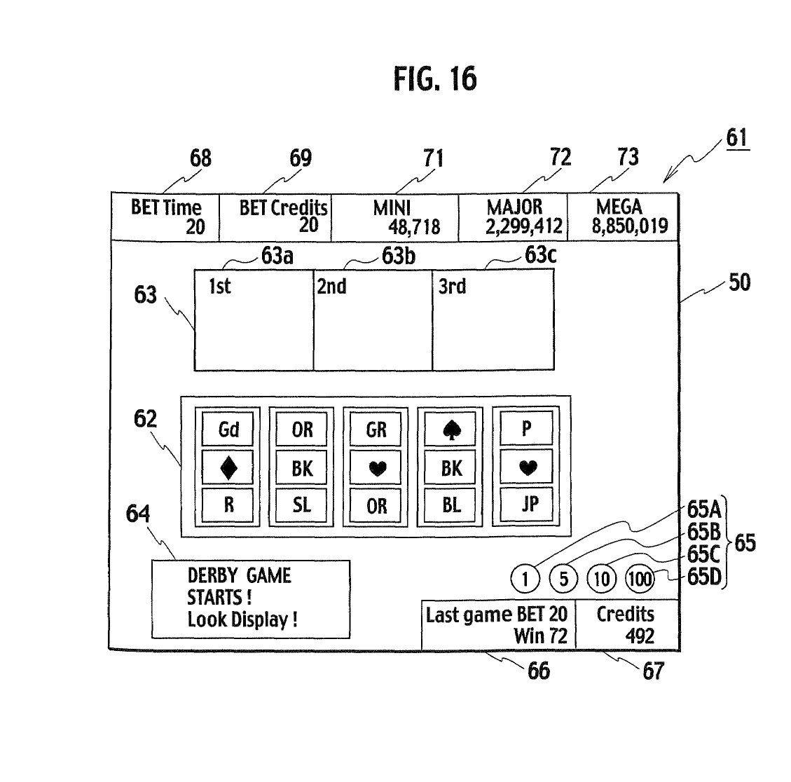

FIG. 16 shows an example of a display which is shown on the game screen 61 when the primary game is completed. FIG. 16 shows that in the symbol displaying region 62, the “Gd (gold) HORSE” symbol is rearranged in the symbol displaying sub-region 62aX; the “DIAMOND” symbol, 62aY; the “R (red) HORSE” symbol, 62aZ; an “OR (orange) HORSE” symbol, 62bX; the “BK (black) HORSE” symbol, 62bY; the “SL (silver) HORSE” symbol, 62bZ; the “GR (green) HORSE” symbol, 62cX; the “HEART” symbol, 62cY; an “OR HORSE” symbol, 62cZ; the “SPADE” symbol, 62dX; the “BK HORSE” symbol, 62dY; the “BL (blue) HORSE” symbol, 62dZ; the “P (pink) HORSE” symbol, 62eX; the “HEART” symbol, 62eY; the “JP (jackpot)” symbol, 62eZ. Furthermore, in response to the completion of the primary game, a character image of “Derby Game Starts” is displayed in the message displaying section 64 (step S11).

The Derby game (horse race) as the secondary game is displayed on the display 20. The outcome of the Derby game, that is to say, the ranking, the colors of the “HORSE” symbols and the symbols combined with the “HORSE” symbols such as “SPADE”, “HEART”, “DIAMOND” and “CLUB,” is transmitted to each station 4, and is displayed in the secondary game outcome displaying section 63 therein (see FIG. 1). The secondary game outcome displaying section 63 displays the outcome of the secondary game displayed on the display 20 on the basis of the ranking. In the present embodiment, the “BK HORSE” symbol is displayed as a symbol of a horse winning first place; the “P HORSE” symbol, second place; and the “R HORSE” symbol, third place. The “SPADE”, “HEART”, “DIAMOND” and “CLUB,” symbols are combined with the “HORSE” symbols used in the secondary game (see FIG. 8). When the ranking is decided, information on “SPADE”, “HEART”, “DIAMOND” and “CLUB,” combined with the horse symbols as well as the placing is simultaneously displayed in the secondary game outcome displaying section 63.

As described above, the gaming machine 1 shown as the embodiment of the present invention causes each station 4 to carry out its slot game, and thereafter develops the secondary game shared among the stations 4 after the slot game in each station 4 is completed. Thereby, the gaming machine 1 realizes new entertainment features obtained by combining excellent entertainment features of the conventional stand-alone type of gaming devices with the multiplayer mass game.

The foregoing descriptions have been provided for the game system according to the embodiment of the present invention. Such descriptions aim at only illustrating a concrete example of the game system, and do not impose any specific restriction on the present invention. The design for the concrete configuration can be modified on the basis of the necessity. The effects of the embodiment of the present invention have been described only for the purpose of enumerating the most desirable effects brought about by the present invention. The effects of the present invention are not limited to those described for the embodiment of the present invention. In the case of the embodiment, the secondary game has been described as being carried out as the video game on the display 20. For example, however, the secondary game may be carried out by use of a publicly-known gaming device having rails laid out on a game board representing a miniaturized race course, on which rails multiple horse models are changed with power of a drive motor. In this case, the placing of the horse models are designed to be decided by use of random numbers or the like after the secondary game is started, but before the horse models pass the goal line. Thus, the drive motor is designed to be controlled in order that the models reach the goal with the placing.

What is claimed is:

1. A gaming machine comprising:
a plurality of gaming devices each carrying out a game in which a plurality of symbols having attributes different from each other are changed and subsequently stopped;
a shared gaming device carrying out a shared game shared by the gaming devices; and
a display displaying the shared game, the display being visible to players each playing the game in one of the gaming devices,
wherein each of the gaming devices is operable to:
(a) change the plurality of symbols and subsequently stop them; and
(b) provide an award on the basis of a relationship between a combination of the symbols formed when the symbols are stopped and an outcome of the shared game.

2. The gaming machine according to claim 1, wherein each of the gaming devices is operable to:
(a) change the plurality of symbols and subsequently stop them;
(b) temporarily determine a corresponding award when a specific combination is formed in a combination of the symbols formed when the symbols are stopped; and
(c) change the temporarily-determined award according to the outcome of the shared game.

3. A gaming machine comprising:
a plurality of gaming devices each carrying out a game in which a plurality of symbols having attributes different from each other are changed and subsequently stopped;
a shared gaming device carrying out a shared game in which predetermined symbols are sampled from a plurality of symbols including the symbols used in each of the gaming devices; and
a display displaying a content of the shared game, the display being visible to players each playing the game in one of the gaming devices,
wherein each of the gaming devices is operable to:
(a) change the plurality of symbols and subsequently stop them; and
(b) provide an award according to a relationship between a combination of the symbols formed when the symbols are stopped and the predetermined symbols sampled in the shared game.

4. The gaming machine according to claim 3, wherein each of the gaming devices is operable to:
(a) change the plurality of symbols and subsequently stop them;
(b) temporarily determine a corresponding award when a specific combination is formed in a combination of the symbols formed when the symbols are stopped; and
(c) change the temporarily-determined award according to the symbols sampled in the shared game.

5. A gaming machine comprising:
a plurality of primary gaming devices each carrying out a primary game in which a plurality of symbols having attributes different from each other are changed and subsequently stopped;
a secondary gaming device carrying out a secondary game in which predetermined symbols are sampled from a plurality of symbols including the symbols used in the primary game in each of the primary gaming devices; and
a display displaying a content of the secondary game, the display being visible to players each playing the primary game in one of the primary gaming devices,
wherein each of the primary gaming devices is operable to:
(a) change the plurality of symbols and subsequently stop them as the primary game; and
(b) provide an award according to a relationship between a combination of the symbols formed when the symbols are stopped in the primary game and the predetermined symbols sampled in the secondary game, and
wherein the secondary gaming device is operable to
(c) execute a control such that the secondary game can be started at a timing when the primary game is completed in each of the primary gaming devices, and that the symbols sampled in the secondary game can be supplied to the primary game.

6. The gaming machine according to claim 5, wherein each of the primary gaming devices is operable to:
(a) change the plurality of symbols and subsequently stop them as the primary game;
(b) temporarily determine a corresponding award when a specific combination formed in a combination of the symbols formed when the symbols are stopped; and
(c) change the temporarily-determined award according to the symbols sampled in the secondary game.

7. A method of controlling a gaming machine including a shared gaming device and a plurality of gaming devices, comprising:
causing each of the plurality of gaming devices to change and subsequently stop a plurality of symbols having attributes different from each other;
causing a shared gaming device to sample predetermined symbols from a plurality of symbols including the symbols used in each of the gaming devices as a shared game displayed on a display; and
providing an award according to a relationship between a combination of the plurality of symbols which are changed and subsequently stopped in each of the gaming devices and an outcome of the shared game.
